(19) United States
(12) Patent Application Publication
(10) Pub. No.: US 2024/0337851 A1
(43) Pub. Date: Oct. 10, 2024

(54) HEAD MOUNTED DISPLAY

(71) Applicant: CANON KABUSHIKI KAISHA, Tokyo (JP)

(72) Inventor: KOICHI ODAGAKI, Kanagawa (JP)

(21) Appl. No.: 18/599,329

(22) Filed: Mar. 8, 2024

(30) Foreign Application Priority Data
Apr. 7, 2023 (JP) 2023-063038

(51) Int. Cl. G02B 27/01

(52) U.S. Cl. CPC G02B 27/0176; G02B 2027/0138; G02B 2027/0163; G02B 2027/0178

(57) ABSTRACT

Provided is a head mounted display in which noise such as crosstalk caused by signal interference can be reduced. The head mounted display having a frame connecting left and right temporal regions includes a first wiring configured to be formed in the frame using an MID so as to perform electrical connection between a control board disposed on one temporal region side and a circuit board disposed on the other temporal region side.

### BACKGROUND OF THE INVENTION

### Field of the Invention

The present invention relates to a head mounted display.

### Description of the Related Art

Head mounted displays (which will hereinafter be referred to as HMDs) and the like are becoming smaller and lighter. For example, Japanese Patent Laid-Open No. 2023-036737 discloses a head mounted-type display device having a constitution in which a display unit is disposed next to the face and an image of the display unit is subjected to light guiding such that the image is guided to the eyes of a wearer.

However, generally, in HMDs and the like, wirings such as flexible circuit boards are often used between a liquid crystal display or the like serving as a display element and a control circuit. For this reason, flexible circuit boards that electrically connect a board disposed on one temporal region side and another board disposed on the other temporal region side encircle an HMD along a frame, resulting in difficulty in assemblability. In addition, there is concern that crosstalk due to signal interference may occur because the flexible circuit boards overlap each other.

In particular, as devices become smaller and lighter, the foregoing problems are more likely to occur. However, in HMDs in the related art, sufficient countermeasures have not been taken against occurrence of such noise.

### SUMMARY OF THE INVENTION

A head mounted display according to an aspect of the present invention has a frame connecting left and right temporal regions. The head mounted display includes a first wiring configured to be formed in the frame using an MID so as to perform electrical connection between a control board disposed on one temporal region side and a circuit board disposed on the other temporal region side.

Further features of the present invention will become apparent from the following description of embodiments with reference to the attached drawings.

### BRIEF DESCRIPTION OF THE DRAWINGS

FIG. 1 is a schematic view showing an example of a constitution of a head mounted-type display device of First Embodiment of the present invention viewed from above the head.

FIG. 2 is an enlarged schematic cross-sectional view of an area around a control board 112.

FIG. 3 is a schematic view showing an example of a separation wall according to Second Embodiment.

FIG. 4 is a schematic view showing another example of the separation wall according to Third Embodiment.

FIG. 5 is a perspective view showing an example of a schematic constitution of an HMD 500 according to Fourth Embodiment.

FIG. 6 is a perspective view showing an example of a schematic constitution of an HMD 600 according to Fifth Embodiment.

FIGS. 7A and 7B are explanatory views of a disposition example of a wiring 506 and a wiring 601.

FIG. 8 is a perspective view showing an example of a schematic constitution of an HMD 800 according to Sixth Embodiment.

### DESCRIPTION OF THE EMBODIMENTS

Hereinafter, embodiments of the present invention will be described with reference to the drawings. However, the present invention is not limited to the following embodiments. In each of the drawings, the same reference signs are applied to members or elements which are the same, and duplicate description will be omitted or simplified.

### First Embodiment

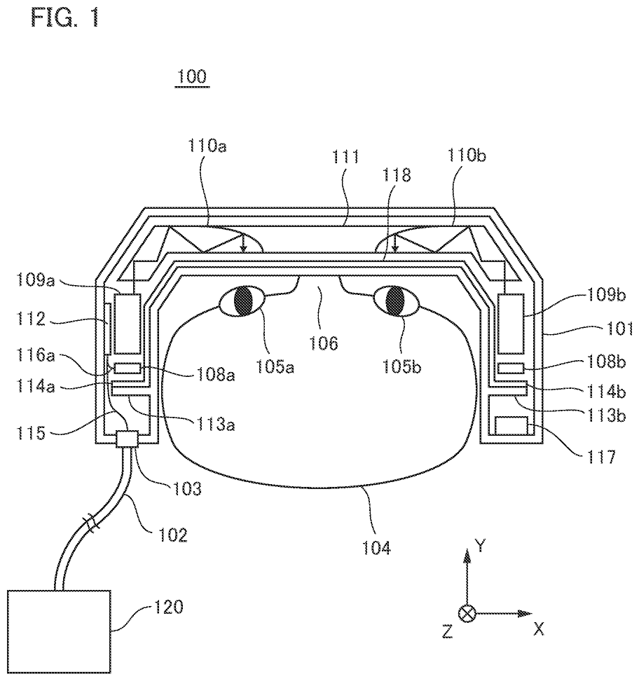

FIG. 1 is a schematic view showing an example of a constitution of a head mounted-type display device of First Embodiment of the present invention viewed from above the head. In First Embodiment, as an electronic instrument, as shown in FIG. 1, a head mounted display (HMD) 100 will be described as an example of a head mounted-type display device, but the electronic instrument of First Embodiment is not limited to an HMD.

In FIG. 1, the reference sign 101 indicates a casing of the HMD 100, which serves as a head mounted-type display device and is constituted by assembling a plurality of units molded using a resin. The reference sign 120 indicates an external terminal. For example, a CPU serving as a computer and a memory serving as a storage medium storing computer programs are built into this.

In addition, for example, a wireless communication device is built into the external terminal 120. For example, it has a video image storage device storing video images downloaded from a network through the wireless communication device. For example, the external terminal 120 is connected to the HMD 100 through a wired cable 102 and a connector 103.

The reference sign 104 indicates the head. The reference signs 105a and 105b respectively indicate the left eyeball and the right eyeball. The reference sign 106 schematically shows the nose. The casing 101 of the HMD of Present Embodiment is mounted on the head using a belt, a hook, a nose pad, or the like. However, since a structure for mounting on the head is well known, it is omitted in the diagrams.

For example, the reference signs 108a and 108b indicate display element such as LCDs. The reference signs 109a and 109b respectively indicate image forming optical systems for forming images displayed by the display elements 108a and 108b. The reference signs 110a and 110b respectively indicate light guide optical systems for guiding images formed by the image forming optical systems 109a and 109b to the eyeballs 105a and 105b, and they may have power as lenses.

Images displayed by the display elements 108a and 108b are respectively guided to the eyeballs 105a and 105b through the image forming optical systems 109a and 109b and the light guide optical systems 110a and 110b. Here, the light guide optical system 110a forms a display unit for the left eye and the light guide optical system 110b constitutes a display unit for the right eye. The arrows inside the light guide optical systems 110a and 110b shown in the diagram schematically indicate a situation of light guiding.

The reference sign 111 indicates a translucent member. The reference sign 112 indicates a control board, which includes a control circuit or the like such as a CPU. The control board 112 controls all the circuits inside the HMD 100, and the control board 112 and each of the display elements 108a and 108b are electrically connected to the others through flexible printed circuits (which will hereinafter be abbreviated as FCBs) 116a and 116b, for example.

Here, the FCBs 116a and 116b function as first flexible wiring members, and a control signal for controlling the display elements flows in the first flexible wiring members. In addition, a wiring 115 serving as a second flexible wiring member is provided between the control board 112 and the connector 103, and a signal for communication with an external instrument is transmitted in the second flexible wiring member.

In this manner, the FCBs 116a and 116b serving as the first flexible wiring members and the wiring 115 serving as the second flexible wiring member are accommodated inside the casing 101 serving as an accommodation member which is molded using a resin. The FCB 116b that is a wiring between the control board 112 and the display element 108b is omitted in FIG. 1.

The reference signs 113a and 113b respectively indicate separation walls, and the separation wall 113a curbs occurrence of noise (crosstalk) between the FCB 116a and the wiring 115 by separating the FCB 116a and the wiring 115.

In addition, the separation wall 113a is disposed between the FCB 116a serving as the first flexible wiring member and the wiring 115 serving as the second flexible wiring member and is integrally molded with the casing 101 serving as the accommodation member.

That is, the separation walls 113a and 113b are molded as a part of the resin casing 101. In addition, on one surfaces of the resin separation walls 113a and 113b, shield surfaces 114a and 114b serving as shield electrode patterns are formed on the surfaces using a molded interconnect device (MID). That is, the shield surface 114a (shield electrode pattern) formed using an MID is provided on the separation wall 113a.

A molded interconnect device (MID) is a device in which an electrode, a circuit, and the like are formed on a surface of a resin molded article having a three-dimensional shape. In addition, an MID method includes a method of forming a wiring by plating, and an in-mold electronics (IME) method in which a film-like circuit is integrated by insert molding.

The shield surfaces 114a and 114b are made of metal in a form of this films, for example. The shield surface 114a enhances an effect of curbing occurrence of noise between the FCB 116a and the wiring 115. The shield surfaces 114a and 114b may be in a form of metal meshes or grids.

The shield surfaces 114a and 114b serving as shield electrode patterns are respectively formed on only one surfaces of the separation walls instead of both surfaces of the separation walls 113a and 113b. Accordingly, a parasitic capacitance is reduced.

The reference sign 113b indicates a separation wall similar to 113a and is provided to separate the FCB 116b (not shown) around the display element 108b and a wiring (not shown) for a peripheral circuit board 117. In addition, the shield surface 114b enhances an effect of curbing occurrence of noise (crosstalk) between the FCB 116b and the wiring (not shown) for the peripheral circuit board 117.

In FIG. 1, in a similar manner, the shield surfaces 114a and 114b are electrically connected to each other by a shield surface (shield electrode) 118, for example, formed on an inner wall surface of the resin casing 101 using an MID. In addition, the shield surfaces 114a, 114b, and 118 are electrically connected to ground electrodes (GND electrodes, not shown) on electric circuits included in the control board 112, the display elements 108a and 108b, the peripheral circuit board 117, and the like.

That is, ground electrodes of the control board and the like are electrically connected to the shield electrode patterns formed on the accommodation member using an MID. Furthermore, the shield surface 118 is disposed along the FCB 116b and is connected to a wiring of a ground electrode provided within the FCB 116b.

In this manner, in Present Embodiment, by providing the shield surfaces 114a, 114b, and 118 formed on the surface of the resin casing 101 using an MID, occurrence of noise (crosstalk) can be curbed. Therefore, it is possible to display an image with stable image quality, and it is also possible to comply with EMI standards and the like.

Moreover, since the shield surfaces 114a, 114b, and 118 are formed on a surface such as the inner wall of the resin casing 101 using an MID, even if the inner wall of the casing structure has a complicated uneven shape, sufficient areas for the shield surfaces 114a, 114b, and 118 can be secured.

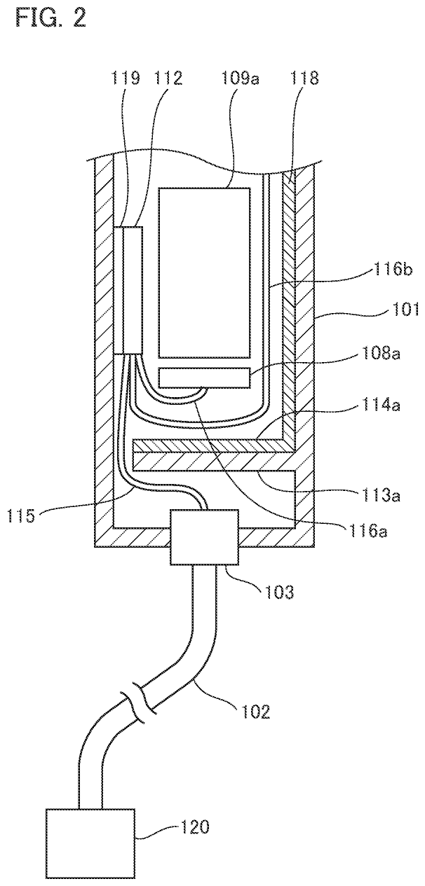

FIG. 2 is an enlarged schematic cross-sectional view of an area around the control board 112. As shown in FIG. 2, the FCB 116b that is a wiring between the control board 112 and the display element 108b is provided. In addition, the reference sign 119 indicates an antenna. It is electrically connected to a wireless communication device (not shown) within the control board 112 and enhances the transmission function when transmitting radio waves to the outside from the control board 112.

The antenna 119 is formed on the surface of the inner wall or the like of the resin casing 101 using an MID. In addition, in FIG. 2, the antenna 119 and the control board have a two-layer structure, and the antenna 119 is sandwiched between the control board 112 and the inner wall of the casing 101.

However, the control board and the antenna may be formed together on the surface of the inner wall or the like of the resin casing 101, for example, using an MID. That is, a control circuit (control board) may be formed on the surface of the casing serving as an accommodation member using an MID. Accordingly, further miniaturization can be achieved.

In Present Embodiment, the antenna 119 is formed on the surface of the inner wall or the like on a side farther from the head 104 inside the casing 101. Moreover, the shield surface 118 is formed on the surface of the inner wall or the like of the casing 101 on a side closer to the head 104.

That is, the shield electrode pattern is provided using an MID in a part of the casing which comes into contact with a user when the user was the head mounted display, and the shield electrode pattern is formed between a user and the antenna using an MID. Therefore, it also has an effect of significantly curbing an influence of electromagnetic wave noise caused by the antenna 119 on the human body.

### Second Embodiment

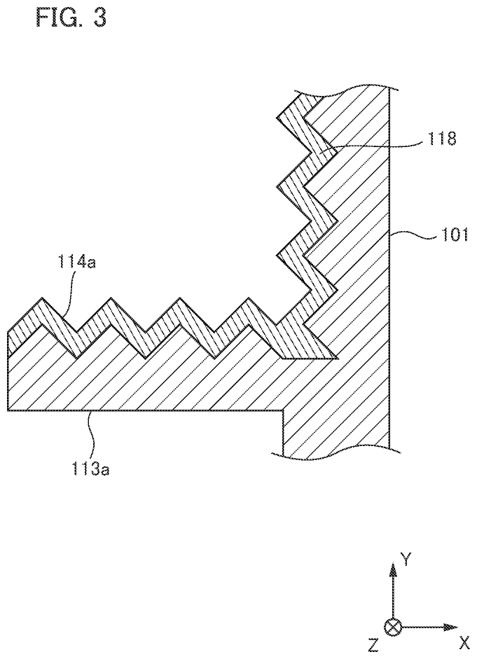

FIG. 3 is a schematic view showing an example of the separation wall according to Second Embodiment. As shown in FIG. 3, one surface of the separation wall 113a may be an uneven surface. Further, the shield surface 114a may be constituted to be formed on one surface (uneven surface) of the separation wall 113a using an MID. By using an MID, the shield surface 114a having a desired area can be formed on such a complicated surface.

In addition, since unevenness is provided on a surface of the separation wall on a side where the shield surface 114a serving as a shield electrode pattern is provided, for example, the contact areas with respect to the FCBs 116a and 116b or the areas of parts close to them can be reduced. Therefore, the parasitic capacitance (coupling capacitance) with respect to the FCBs 116a and 116b can be reduced, and rounding or the like of the signal waveform can be curbed. The unevenness need only be formed in parts that may come into contact with at least the wiring members.

In FIG. 3, a projection portion on one surface of the separation wall 113a may be formed in a ridge shape on a surface of the separation wall 113a or the like or may be discretely disposed in a two-dimensional manner on a surface of the separation wall 113a or the like.

### Third Embodiment

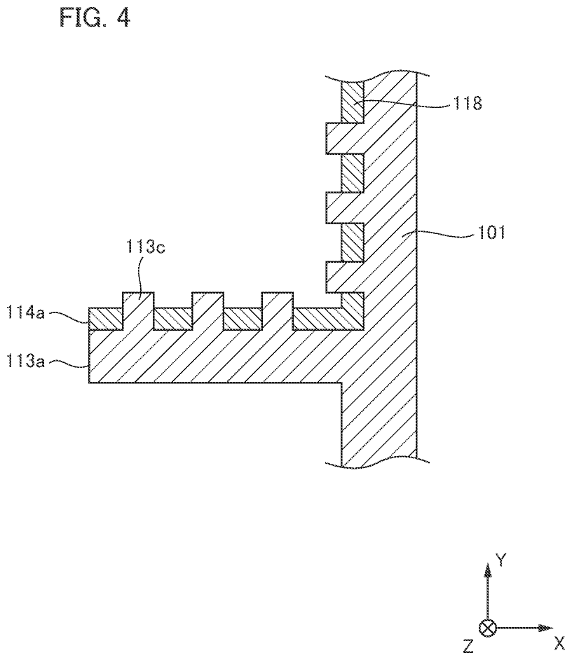

FIG. 4 is a schematic view showing another example of the separation wall according to Third Embodiment. As shown in FIG. 4, one surface of the separation wall 113a may be a surface having a projection portion 113c. Further, the shield surface 114a may be constituted to be formed on a surface other than the projection portion 113c on one surface of the separation wall 113a, that is, a recessed portion using an MID. By using an MID, the shield surface 114a having a desired area can be formed on such a complicated surface.

Due to such a constitution, for example, the contact areas with respect to the FCBs 116a and 116b or the areas of parts close to them can be reduced. Therefore, the parasitic capacitance (coupling capacitance) with respect to the FCBs 116a and 116b can be reduced, and rounding or the like of the signal waveform can be curbed.

In FIG. 4, the projection portion 113c on one surface of the separation wall 113a may be constituted in a ridge shape on a surface of the separation wall 113a or may be discretely disposed in a two-dimensional manner on a surface of the separation wall 113a.

### Fourth Embodiment

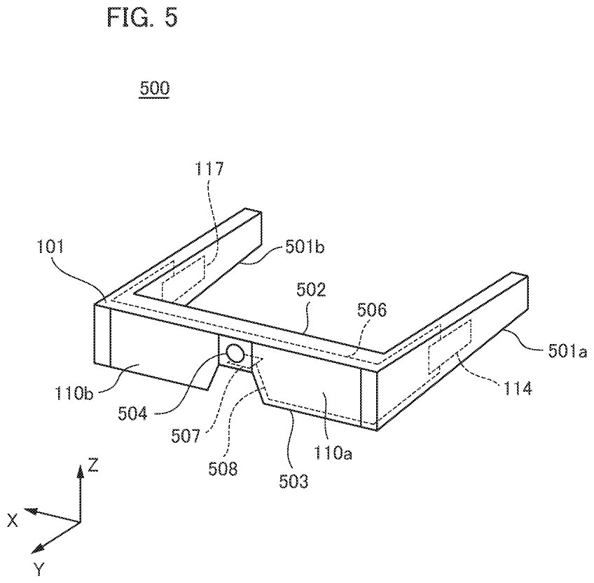

FIG. 5 is a perspective view showing an example of a schematic constitution of an HMD 500 according to Fourth Embodiment. In FIG. 5, the reference sign 101 indicates a resin casing. The reference signs 501a and 501b indicate temporal regions of the HMD. The reference sign 502 indicates an upper frame of the casing 101, and the reference sign 503 indicates a lower frame of the casing 101. The reference signs 110a and 110b indicate light guide optical systems similar to those in FIG. 1.

The light guide optical systems 110a and 110b are sandwiched and held from above and below by the upper frame 502 and the lower frame 503. In addition, a frame connecting the left and right temporal regions 501a and 501b is constituted of the upper frame 502 and the lower frame 503.

Similar to those in FIG. 1, the display elements 108a and 108b (not shown) are respectively provided in the temporal regions 501a and 501b. Images displayed in the display elements 108a and 108b are constituted to be projected as virtual images respectively through the image forming optical systems 109a and 109b (not shown) and the light guide optical systems 110a and 110b and be incident on the eyeballs 105a and 105b.

The reference sign 504 indicates a camera provided in the frame and captures images of a subject in front. An image capturing optical system, a CMOS image sensor, and the like are built into camera 504. The reference sign 507 indicates a camera drive board for driving the camera 504. The reference sign 114 indicates a control board provided inside the temporal region 501a, and it is the same as the control board in FIG. 1. The reference sign 117 indicates a peripheral circuit board provided inside the temporal region 501b, and it is similar to that shown in FIG. 1.

In Fourth Embodiment, a first wiring is formed in one of the upper frame 502 and the lower frame 503 using an MID, and a second wiring is formed in the other using an MID. Specifically, a wiring 506 (first wiring) connecting the control board 112 and the peripheral circuit board 117 is formed on a surface of the inner wall of the upper frame 502, for example, in the casing 101 of the resin HMD using an MID.

That is, the first wiring formed in the frame using an MID is provided so as to perform electrical connection between the control board disposed on one temporal region side and the circuit board disposed on the other temporal region side. In addition, a wiring 508 (second wiring) connecting the control board 112 and the camera drive board 507 is formed on a surface of the inner wall of the lower frame 503, for example, in the casing 101 of the resin HMD using an MID. That is, the second wiring formed in the frame using an MID is provided so as to perform electrical connection between the control board 112 and the camera 504.

Due to such a constitution, the wirings 506 and 508 can be formed on complicated uneven surfaces present inside the casing 101. Therefore, miniaturization of the HMD 500 can be realized.

### Fifth Embodiment

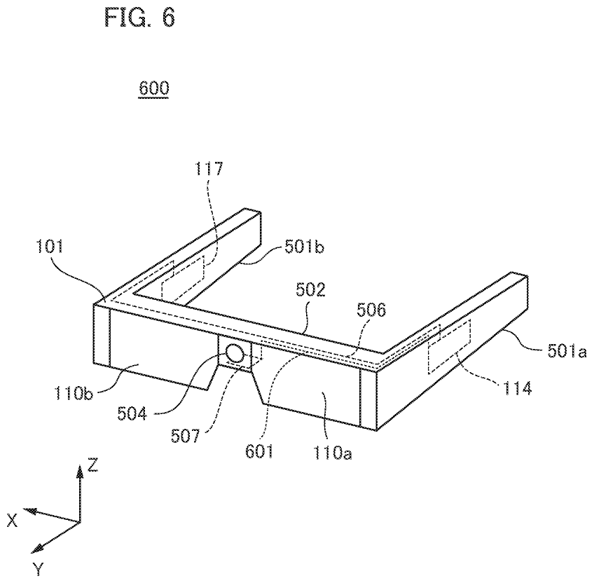

FIG. 6 is a perspective view showing an example of a schematic constitution of an HMD 600 according to Fifth Embodiment. In Fifth Embodiment, a wiring 601 connecting the control board 112 and the camera drive board 507 is formed on a surface of the inner wall of the upper frame 502, for example, in the casing 101 of the resin HMD using an MID. At this time, the wiring 601 and the wiring 506 may be provided on a surface on the same side of the upper frame 502 or may be provided on surfaces of the upper frame 502 opposite to each other.

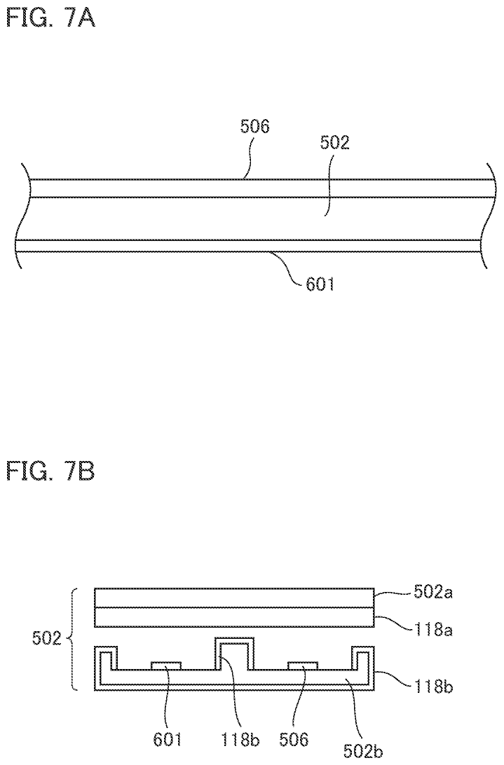

FIGS. 7A and 7B are explanatory views of a disposition example of the wiring 506 and the wiring 601. FIG. 7A is an explanatory view of an example when the wiring 506 and the wiring 601 are formed on surfaces of the upper frame 502 of the resin casing 101 opposite to each other using an MID.

That is, in the example of FIG. 7A, the wirings having different connection destinations are formed on respective surfaces, such as an upper side surface and a lower side surface, of the upper frame using an MID. More specifically, the first wiring is formed on the upper side surface of the upper frame 502 using an MID, and the second wiring is formed on the lower side surface using an MID. The casing 101 may further have a protective casing or a cover on the outer side.

FIG. 7B is a cross-sectional view of the upper frame 502 in the Y direction for describing an example when the wiring 506 and the wiring 601 are formed on a surface of the upper frame 502 of the resin casing 101 on the same side using an MID as in FIG. 6.

In the example of FIG. 7B, the upper frame 502 of the casing 101 is constituted of a casing 502a on the upper side and a casing 502b on the lower side. A shield surface 118a is formed on a surface on the lower side of the casing 502a on the upper side using an MID. In addition, a shield surface 118b is also formed on the lower surface, the side surface, and a part of the upper surface of the casing 502b on the lower side, and a projected surface between the wiring 506 and the wiring 601 using an MID. The shield surface 118b is separated from the wirings 506 and 601.

In addition, the casing 502a on the upper side and the casing 502b on the lower side are fastened by a fastening means (not shown), and the shield surfaces 118a and 118b are constituted to be electrically connected to each other. In addition, as described above, the shield surfaces 118a and 118b are electrically connected to the ground electrodes (GND electrodes) in each of the circuits.

Therefore, the wiring 506 and the wiring 601 are surrounded by a ground potential due to the shield surfaces 118a and 118b so that occurrence of noise can be curbed. In the case of the example in FIG. 7(B) as well, protective casings or covers may be disposed on the outer sides of the casings 502a and 502b. The wiring 506 and the wiring 601 may not be completely surrounded by a ground potential due to the shield surfaces 118a and 118b.

### Sixth Embodiment

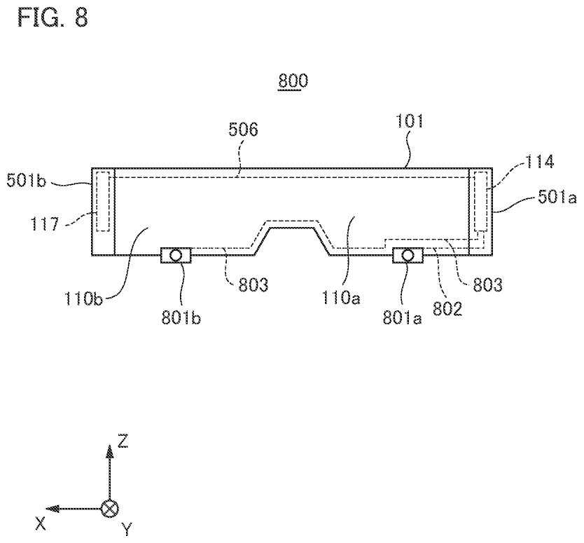

FIG. 8 is a perspective view showing an example of a schematic constitution of an HMD 800 according to Sixth Embodiment. In Sixth Embodiment, two cameras are provided. In FIG. 8, the reference sign 101 indicates a resin casing of the HMD 800. The reference signs 501a and 501b indicate the temporal regions of the HMD. The reference signs 110a and 110b indicate light guide optical systems similar to those in FIGS. 1 and 5, for example.

Similar to FIG. 1, the display elements 108a and 108b (not shown) are respectively provided inside the temporal regions 501a and 501b. Images displayed in the display elements 108a and 108b are constituted to be projected as virtual images respectively through the image forming optical systems 109a and 109b (not shown) and the light guide optical systems 110a and 110b and be incident on the eyeballs 105a and 105b.

In Present Embodiment, cameras 801a and 801b are respectively disposed below the display unit for the left eye and the display unit for the right eye. The cameras 801a and 801b capture stereo images of a subject in front. Image capturing optical systems, CMOS image sensors, and the like are respectively built into them.

The reference sign 114 indicates a control board provided inside the temporal region 501a, and it is the same as the control board in FIG. 1. The reference sign 117 indicates a peripheral circuit board provided inside the temporal region 501b, and it is similar to that shown in shown in FIG. 1.

Similar to Fourth Embodiment, the wiring 506 connecting the control board 112 and the peripheral circuit board 117 is formed on a surface of the inner wall, for example, in the upper frame of the casing 101 of the resin HMD using an MID. In addition, wirings 802 and 803 for respectively connecting the control board 112 and the cameras 801a and 801b are formed on a surface of the inner wall, for example, in the lower frame of the casing 101 of the resin HMD using an MID.

Due to such a constitution, the wirings 506, 802, and 803 can be formed on complicated uneven surfaces present inside the casing 101. Therefore, miniaturization of the HMD 800 can be realized.

While the present invention has been described with reference to exemplary embodiments, it is to be understood that the invention is not limited to the disclosed exemplary embodiments. The scope of the following claims is to be accorded the broadest interpretation to encompass all such modifications and equivalent structures and functions.

This application claims the benefit of priority from Japanese Patent Application No. 2023-063038, filed on Apr. 7, 2023, which is hereby incorporated by reference herein in its entirety.

What is claimed is:

1. A head mounted display having a frame connecting left and right temporal regions, the head mounted display comprising:
a first wiring configured to be formed in the frame using an MID so as to perform electrical connection between a control board disposed on one temporal region side and a circuit board disposed on the other temporal region side.

2. The head mounted display according to claim 1 further comprising:
cameras configured to be provided in the frame; and
a second wiring configured to be formed in the frame using an MID so as to perform electrical connection between the control board and the cameras.

3. The head mounted display according to claim 2,
wherein the frame has an upper frame and a lower frame, the first wiring is formed in one of the upper frame and the lower frame using an MID, and the second wiring is formed in the other of the upper frame and the lower frame using an MID.

4. The head mounted display according to claim 3,
wherein the first wiring is formed in the upper frame using an MID, and the second wiring is formed in the lower frame using an MID.

5. The head mounted display according to claim 3,
wherein wirings having different connection destinations are respectively formed on an upper side surface and a lower side surface of the upper frame using an MID.

6. The head mounted display according to claim 5,
wherein the first wiring is formed on the upper side surface of the upper frame using an MID, and the second wiring is formed on the lower side surface of the upper frame using an MID.

7. The head mounted display according to claim 1,
wherein the frame has a display unit for the right eye and a display unit for the left eye, and cameras are respectively disposed in lower portions of the display unit for the right eye and the display unit for the left eye.

8. The head mounted display according to claim 1,
wherein a shield electrode pattern formed using an MID in a part of a casing that comes into contact with a user is provided when the user was the head mounted display.

9. The head mounted display according to claim 8,
wherein a ground electrode of the control board is electrically connected to the shield electrode pattern formed using an MID.

10. The head mounted display according to claim 9,
wherein the first wiring is configured to be surrounded by the shield electrode pattern.
